(19) United States
(12) Patent Application Publication
(10) Pub. No.: US 2025/0198390 A1
(43) Pub. Date: Jun. 19, 2025

(54) DETERIORATION DETECTION SYSTEM, DETERIORATION DETECTION APPARATUS, AND DETERIORATION DETECTION METHOD

(71) Applicant: NEC Corporation, Minato-ku, Tokyo (JP)

(72) Inventor: Tadayuki IWANO, Tokyo (JP)

(73) Assignee: NEC Corporation, Minato-ku, Tokyo (JP)

(21) Appl. No.: 18/836,044

(22) PCT Filed: Mar. 23, 2022
(86) PCT No.: PCT/JP2022/013737

§ 371 Date: Aug. 6, 2024

(51) Int. Cl. F03D 17/00; G01M 5/00

(52) U.S. Cl. CPC F03D 17/015; G01M 5/0033; G01M 5/0066

(57) ABSTRACT

A deterioration detection system according to the present disclosure includes an optical fiber (10) that is laid along a wind turbine (30) for power generation; a communication unit (21) configured to transmit pulsed light to the optical fiber (10) and receive an optical signal including information indicating vibration of the wind turbine from the optical fiber (10); and a detection unit (22) configured to detect deterioration of the wind turbine (30) on the basis of the information indicating the vibration of the wind turbine (30), the information being included in the optical signal.

### TECHNICAL FIELD

The present disclosure relates to a deterioration detection system, a deterioration detection apparatus, and a deterioration detection method which detect deterioration of a wind turbine for power generation.

### BACKGROUND ART

In recent years, offshore wind power generation has been developed.

In offshore wind power generation, a wind turbine for power generation is installed on the sea, and power is generated by the wind turbine.

On the other hand, in recent years, a technology called optical fiber sensing using an optical fiber as a sensor has also been developed. Examples of the technology for performing optical fiber sensing in the ocean include a technology disclosed in Patent Literature 1.

### CITATION LIST

### Patent Literature

Patent Literature 1: Published Japanese Translation of PCT International Publication for Patent Application, No. 2020-508464

### SUMMARY OF INVENTION

### Technical Problem

As described above, in offshore wind power generation, a wind turbine for power generation is installed on the sea. Therefore, there is a demand for remotely monitoring a wind turbine on land or the like and detecting deterioration of the wind turbine by optical fiber sensing capable of remote monitoring.

However, the technology disclosed in Patent Literature 1 is a technology for monitoring a buried state of a subsea power cable or a remote communication cable, and cannot detect deterioration of a wind turbine.

Therefore, in view of the above-described problems, an object of the present disclosure is to provide a deterioration detection system, a deterioration detection apparatus, and a deterioration detection method which can detect deterioration of a wind turbine by optical fiber sensing.

### Solution to Problem

A deterioration detection system according to an aspect includes an optical fiber that is laid along a wind turbine for power generation: a communication unit configured to transmit pulsed light to the optical fiber and receive an optical signal including information indicating vibration of the wind turbine from the optical fiber; and a detection unit configured to detect deterioration of the wind turbine on the basis of the information indicating the vibration of the wind turbine, the information being included in the optical signal.

A deterioration detection apparatus according to another aspect includes a communication unit configured to transmit pulsed light to an optical fiber laid along a wind turbine for power generation and receive an optical signal including information indicating vibration of the wind turbine from the optical fiber; and a detection unit configured to detect deterioration of the wind turbine on the basis of the information indicating the vibration of the wind turbine, the information being included in the optical signal.

A deterioration detection method according to another aspect is a deterioration detection method performed by a deterioration detection apparatus, and the deterioration detection method includes a communication step of transmitting pulsed light to an optical fiber laid along a wind turbine for power generation and receiving an optical signal including information indicating vibration of the wind turbine from the optical fiber; and a detection step of detecting deterioration of the wind turbine on the basis of the information indicating the vibration of the wind turbine, the information being included in the optical signal.

### Advantageous Effects of Invention

According to the above-described aspects, it is possible to provide a deterioration detection system, a deterioration detection apparatus, and a deterioration detection method which can detect deterioration of a wind turbine by optical fiber sensing.

### BRIEF DESCRIPTION OF DRAWINGS

FIG. 1 is a diagram illustrating a configuration example of a deterioration detection system according to a first example embodiment.

FIG. 2 is a diagram illustrating an example of a correspondence table according to the first example embodiment.

FIG. 3 is a flowchart illustrating an example of a flow of a schematic operation of the deterioration detection system according to the first example embodiment.

FIG. 4 is a diagram illustrating a configuration example of a deterioration detection system according to a second example embodiment.

FIG. 5 is a flowchart illustrating an example of a flow of a schematic operation of the deterioration detection system according to the second example embodiment.

FIG. 6 is a diagram illustrating a configuration example of a deterioration detection system according to another example embodiment.

FIG. 7 is a diagram illustrating another configuration example of a deterioration detection system according to another example embodiment.

FIG. 8 is a diagram illustrating an example of a correspondence table according to another example embodiment.

FIG. 9 is a block diagram illustrating a hardware configuration example of a computer that realizes a deterioration detection apparatus according to another example embodiment.

### EXAMPLE EMBODIMENT

Example embodiments of the present disclosure will be described below with reference to the drawings. Note that, in the description and drawings to be described below, omission and simplification are made as appropriate for clarity of description. Furthermore, in the following drawings, the same elements will be denoted by the same reference signs, and redundant description will be omitted as necessary.

### First Example Embodiment

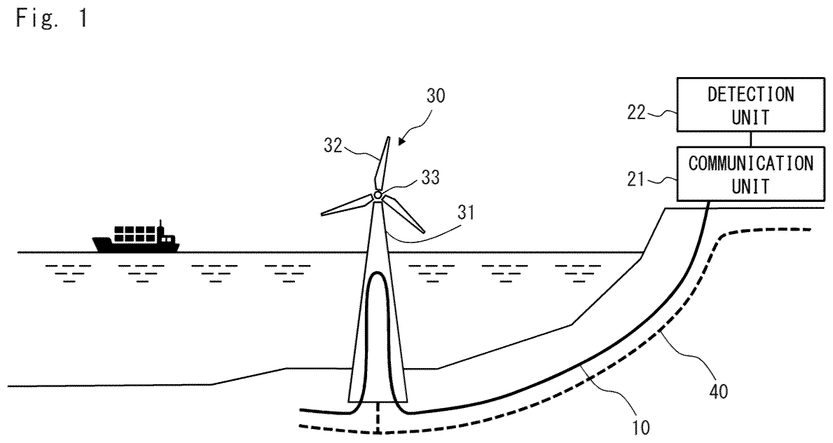

First, a configuration example of a deterioration detection system according to a first example embodiment will be described with reference to FIG. 1.

As illustrated in FIG. 1, the deterioration detection system according to the first example embodiment detects deterioration of a wind turbine 30 for power generation used in offshore wind power generation or the like, and includes an optical fiber 10, a communication unit 21, and a detection unit 22. Note that, in FIG. 1, it is assumed that the communication unit 21 and the detection unit 22 are separately provided. The detection unit 22 may be provided in an apparatus separate from the communication unit 21 or may be provided on a cloud.

The wind turbine 30 illustrated in FIG. 1 has a structure in which blades 32 and the like are assembled on a tower housing 31.

When the wind hits the blades 32, the blades 32 are rotated, and the rotation is transmitted to a speed increasing machine (not illustrated) via a rotation shaft 33 of the blades 32. In the speed increasing machine, the rotational energy of the rotation is amplified, and thereafter, in a generator (not illustrated), the rotational energy is converted into electrical energy. The electric power generated by the wind turbine 30 in this manner is transmitted to a power system (not illustrated) on land via a power transmission cable 40 connected to the above-described generator.

However, the structure of the wind turbine 30 illustrated in FIG. 1 is an example, and the structure of the wind turbine 30 is not limited thereto.

In a portion of the wind turbine 30, the optical fiber 10 is laid along the tower housing 31 of the wind turbine 30. In addition, in a portion other than the wind turbine 30, the optical fiber 10 is laid or buried on the seabed along the power transmission cable 40. In addition, one end of the optical fiber 10 is connected to the communication unit 21.

The communication unit 21 transmits pulsed light to the optical fiber 10. Then, as the pulsed light is transmitted through the optical fiber 10, backscattered light is generated. The communication unit 21 receives the backscattered light from the optical fiber 10 as an optical signal.

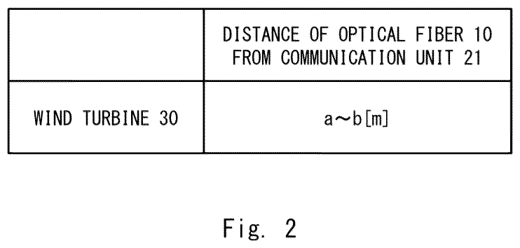

The detection unit 22 can specify a position where the optical signal is generated (the distance of the optical fiber 10 from the communication unit 21) on the basis of the time difference between the time when the pulsed light is transmitted from the communication unit 21 to the optical fiber 10 and the time when the optical signal is received by the communication unit 21 from the optical fiber 10. Therefore, the detection unit 22 can specify the optical signal generated in the wind turbine 30 by collating the position where the optical signal is generated with the correspondence table as illustrated in FIG. 2. Note that the correspondence table of FIG. 2 may be stored in advance in a memory (not illustrated) or the like.

As described above, in the wind turbine 30, the blades 32 are rotated at the time of power generation, and vibration is generated under the influence of the rotation. The vibration generated in the wind turbine 30 is transmitted to the optical fiber 10. As a result, characteristics (for example, a wavelength) of the optical signal transmitted through the optical fiber 10 are changed.

Therefore, the detection unit 22 can detect the vibration of the wind turbine 30 by analyzing the characteristics of the optical signal generated in the wind turbine 30 among the optical signals received by the communication unit 21. From this, the optical signal generated by the wind turbine 30 includes information indicating the vibration of the wind turbine 30.

Here, a vibration state of the vibration generated in the wind turbine 30 varies depending on the presence or absence of deterioration of the wind turbine 30.

Therefore, the detection unit 22 detects deterioration of the wind turbine 30 on the basis of information, which indicates vibration of the wind turbine 30, included in the optical signal generated in the wind turbine 30 among the optical signals received by the communication unit 21.

Hereinafter, an example of a method of detecting deterioration of the wind turbine 30 in the detection unit 22 will be described.

When the wind turbine 30 deteriorates, a power generation amount deviates from a predetermined range, and the vibration frequency of vibration generated in the wind turbine 30 also fluctuates. Here, the vibration frequency means the number of vibrations per unit time. Therefore, it is considered that the power generation amount of the wind turbine 30 has high correlation with the vibration frequency of the wind turbine 30.

Therefore, the detection unit 22 learns in advance the correspondence relationship between the power generation amount and the vibration frequency of the wind turbine 30 using teacher data indicating the power generation amount of the wind turbine 30 and the vibration frequency of the vibration generated in the wind turbine 30 at that time. At this time, as the power generation amount for teacher data, a power generation amount measured on the wind turbine 30 side is used. In addition, as the vibration frequency for the teacher data, a vibration frequency derived by the detection unit 22 analyzing information indicating the vibration of the wind turbine 30 included in the optical signal is used. Note that the detection unit 22 may use a learning model by a convolutional neural network (CNN), for example, in the above-described learning. In this case, the learning model may be stored in advance in a memory (not illustrated) or the like.

When detecting deterioration of the wind turbine 30, the detection unit 22 first derives the vibration frequency of the vibration generated in the wind turbine 30 on the basis of the information indicating the vibration of the wind turbine 30 included in the optical signal generated in the wind turbine 30. Next, the detection unit 22 derives the power generation amount corresponding to the derived vibration frequency from the correspondence relationship learned in advance. Next, the detection unit 22 determines whether or not the derived power generation amount is out of a predetermined range, and determines that the wind turbine 30 has deteriorated in a case where the derived power generation amount is out of the predetermined range.

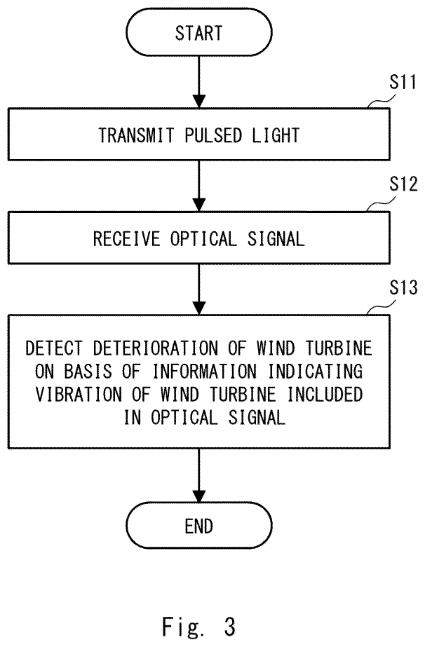

Next, an example of a flow of a schematic operation of the deterioration detection system according to the first example embodiment will be described with reference to FIG. 3.

As illustrated in FIG. 3, first, the communication unit 21 transmits pulsed light to the optical fiber 10 (step S11), and receives backscattered light for the pulsed light from the optical fiber 10 as an optical signal (step S12).

Then, the detection unit 22 detects deterioration of the wind turbine 30 on the basis of information indicating vibration of the wind turbine 30 included in the optical signal generated in the wind turbine 30 among the optical signals received by the communication unit 21 (step S13). At this time, as a method of detecting deterioration of the wind turbine 30, a method using the correspondence relationship between the power generation amount and the vibration frequency of the wind turbine 30 may be used as described above.

As described above, according to the first example embodiment, the communication unit 21 transmits pulsed light to the optical fiber 10, and receives backscattered light for the pulsed light from the optical fiber 10 as an optical signal. The detection unit 22 detects deterioration of the wind turbine 30 on the basis of the information indicating vibration of the wind turbine 30 included in the optical signal received by the communication unit 21. As a result, the wind turbine 30 can be remotely monitored on land or the like by optical fiber sensing, and deterioration of the wind turbine 30 can be detected.

### Second Example Embodiment

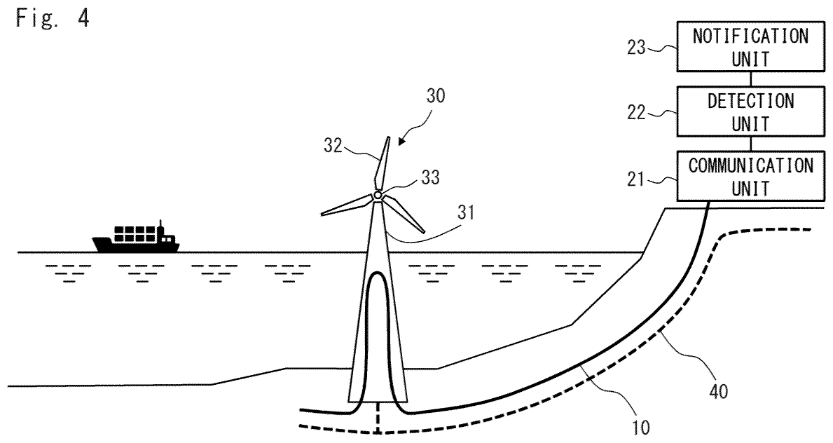

Next, a configuration example of a deterioration detection system according to a second example embodiment will be described with reference to FIG. 4.

As illustrated in FIG. 4, the deterioration detection system according to the second example embodiment is different from the configuration in FIG. 1 according to the above-described first example embodiment in that a notification unit 23 is added.

In a case where the detection unit 22 determines that the wind turbine 30 has deteriorated, the notification unit 23 notifies a predetermined notification destination that the wind turbine 30 has deteriorated. The predetermined notification destination may be, for example, a terminal installed in an electric power company that manages the wind turbine 30, a terminal carried by a worker in charge of the electric power company, or the like. In addition, the notification method may be, for example, a method of displaying a graphical user interface (GUI) screen on a display, a monitor, or the like of the terminal as the notification destination, or a method of outputting a message by voice from a speaker of the terminal as the notification destination.

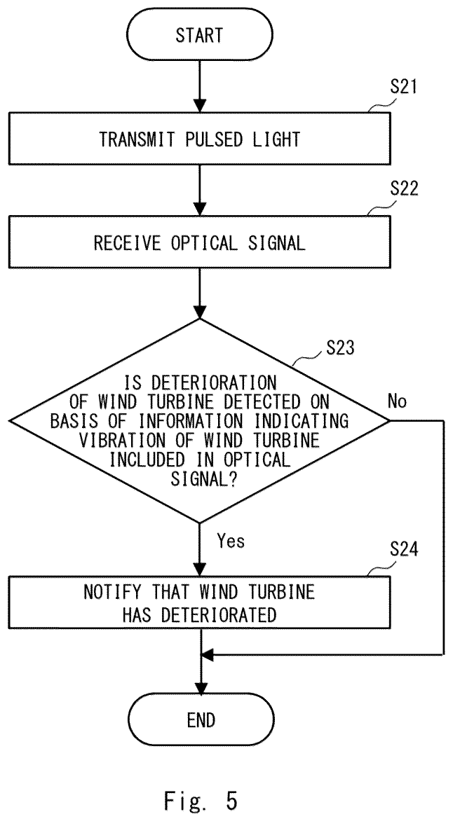

Next, an example of a flow of a schematic operation of the deterioration detection system according to the second example embodiment will be described with reference to FIG. 5.

As illustrated in FIG. 5, first, processing of steps S21 to S23 that are similar to the processing of steps S11 to S13 in FIG. 3 according to the above-described first example embodiment are performed.

In step S23, in a case where the detection unit 22 determines that the wind turbine 30 has deteriorated (Yes in step S23), the notification unit 23 notifies a predetermined notification destination that the wind turbine 30 has deteriorated (step S24).

According to the second example embodiment as described above, in a case where the detection unit 22 determines that the wind turbine 30 has deteriorated, the notification unit 23 notifies a predetermined notification destination that the wind turbine 30 has deteriorated. As a result, it is possible to notify the electric power company or the like, which manages the wind turbine 30, that the wind turbine 30 has deteriorated.

The other effects are similar to the effects according to the above-described first example embodiment.

### Another Example Embodiment

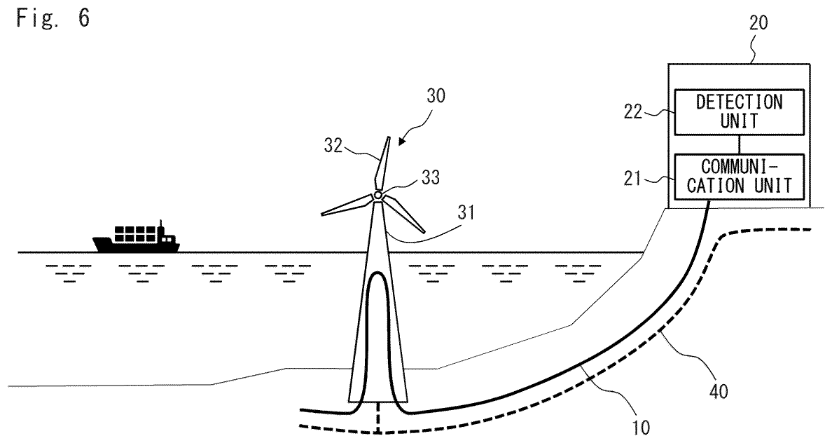

In the above-described example embodiment, the communication unit 21 and the detection unit 22 are separately provided, but the present disclosure is not limited thereto. The communication unit 21 and the detection unit 22 may be provided in the same apparatus. FIG. 6 illustrates a configuration example of a deterioration detection system in which the communication unit 21 and the detection unit 22 are provided inside a deterioration detection apparatus 20. Note that, in the deterioration detection system illustrated in FIG. 6, as in the above-described second example embodiment, the notification unit 23 may be added to the inside of the deterioration detection apparatus 20.

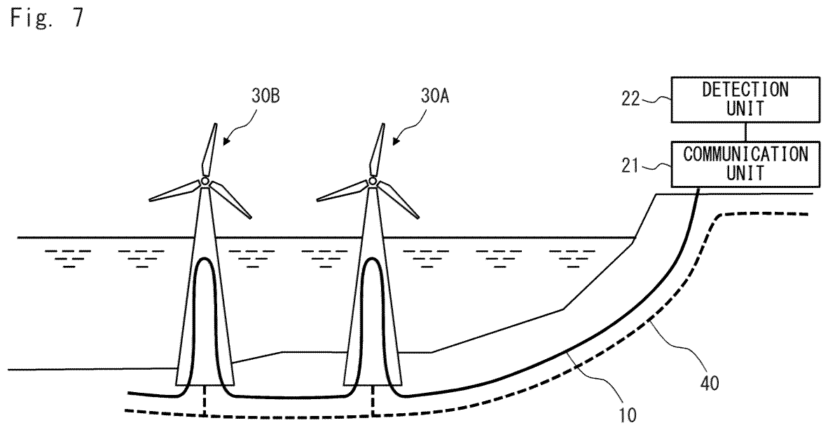

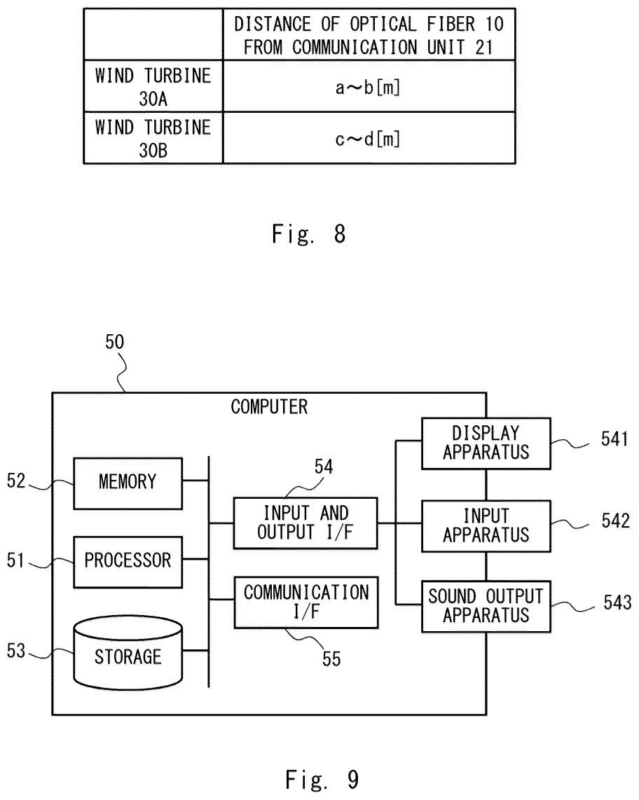

In addition, in the above-described example embodiments, the number of wind turbines 30 to be monitored is one, but the number of wind turbines 30 to be monitored may be plural. FIG. 7 illustrates a configuration example of a deterioration detection system that detects deterioration of each of two wind turbines 30A and 30B. In the case of the deterioration detection system illustrated in FIG. 7, the detection unit 22 can specify the optical signal generated in each of the wind turbine 30A and the wind turbine 30B by collating the correspondence tables as illustrated in FIG. 8. Therefore, the detection unit 22 may detect the deterioration of the wind turbine 30A on the basis of information indicating the vibration of the wind turbine 30A included in the optical signal generated in the wind turbine 30A, and may detect the deterioration of the wind turbine 30B on the basis of information indicating the vibration of the wind turbine 30B included in the optical signal generated in the wind turbine 30B. Note that the correspondence table of FIG. 8 may be stored in advance in a memory (not illustrated) or the like. In addition, in the deterioration detection system illustrated in FIG. 8, the notification unit 23 may be added to the inside of the deterioration detection apparatus 20.

In addition, in the above-described example embodiments, in a portion other than the wind turbine 30, the optical fiber 10 is laid or buried along the power transmission cable 40. Therefore, the vibration generated in the power transmission cable 40 is also transmitted to the optical fiber 10. Therefore, the optical signal generated at the position along the power transmission cable 40 includes information indicating vibration of the power transmission cable 40. In addition, the detection unit 22 can specify the optical signal generated at the position along the power transmission cable 40 by collating the correspondence table as illustrated in FIG. 2 or 8. In addition, the vibration state of the vibration generated in the power transmission cable 40 also varies depending on the presence or absence of deterioration of the power transmission cable 40. Therefore, the detection unit 22 may detect the deterioration of the power transmission cable 40 on the basis of the information indicating the vibration of the power transmission cable 40 included in the optical signal generated at the position along the power transmission cable 40.

For example, the detection unit 22 derives in advance a normal range of the vibration frequency of the vibration generated in the power transmission cable 40. When detecting the deterioration of the power transmission cable 40, the detection unit 22 first derives the vibration frequency of the vibration generated in the power transmission cable 40 on the basis of the information indicating the vibration of the power transmission cable 40 included in the optical signal generated at the position along the power transmission cable 40. Next, the detection unit 22 determines whether or not the derived vibration frequency is out of the normal range derived in advance, and determines that the power transmission cable 40 has deteriorated in a case where the derived vibration frequency is out of the normal range.

### <Hardware Configuration of Deterioration Detection Apparatus According to Example Embodiment>

Next, a hardware configuration example of a computer 50 that implements the deterioration detection apparatus 20 according to the other example embodiment (FIG. 6) described above will be described with reference to FIG. 9.

As illustrated in FIG. 9, the computer 50 includes a processor 51, a memory 52, a storage 53, an input and output interface (input and output I/F) 54, a communication interface (communication I/F) 55, and the like. The processor 51, the memory 52, the storage 53, the input and output interface 54, and the communication interface 55 are connected by a data transmission path for mutually transmitting and receiving data.

The processor 51 is an arithmetic processing unit such as a central processing unit (CPU) or a graphics processing unit (GPU). The memory 52 is, for example, a memory such as a random access memory (RAM) or a read only memory (ROM). The storage 53 is, for example, a storage device such as a hard disk drive (HDD), a solid state drive (SSD), or a memory card. In addition, the storage 53 may be a memory such as a RAM or a ROM.

A program is stored in the storage 53. This program includes a group of commands (or software code) for causing the computer 50 to perform one or more functions of the above-described deterioration detection apparatus 20 in a case of being read by the computer. The constituent elements in the above-described deterioration detection apparatus 20 may be implemented by the processor 51 reading and executing a program stored in the storage 53. In addition, a storage function in the above-described deterioration detection apparatus 20 may be realized by the memory 52 or the storage 53.

Furthermore, the above-described program may be stored in a non-transitory computer-readable medium or a tangible storage medium. As an example and not by way of limitation, the computer readable medium or the tangible storage medium includes a RAM, a ROM, a flash memory, an SSD or other memory technology, a compact disc (CD)-ROM, a digital versatile disc (DVD), a Blu-ray (registered trademark) disk or other optical disk storage, a magnetic cassette, a magnetic tape, a magnetic disk storage, or other magnetic storage devices. The program may be transmitted on a transitory computer readable medium or a communication medium. By way of example, and not limitation, transitory computer-readable or communication media include electrical, optical, acoustic, or other forms of propagated signals.

The input and output interface 54 is connected to a display apparatus 541, an input apparatus 542, a sound output apparatus 543, and the like. The display apparatus 541 is an apparatus that displays a screen corresponding to depiction data processed by the processor 51, such as a liquid crystal display (LCD), a cathode ray tube (CRT) display, and a monitor. The input apparatus 542 is an apparatus that receives an operation input of an operator, and is, for example, a keyboard, a mouse, a touch sensor, or the like. The display apparatus 541 and the input apparatus 542 may be integrated and realized as a touch panel. The sound output apparatus 543 is an apparatus that acoustically outputs a sound corresponding to audio data processed by the processor 51, such as a speaker.

The communication interface 55 transmits and receives data to and from an external apparatus. For example, the communication interface 55 communicates with an external apparatus via a wired communication path or a wireless communication path.

The present disclosure has been described above with reference to the example embodiments, but the present disclosure is not limited to the example embodiments described above. Various modifications that can be understood by those skilled in the art can be made to the configuration and details of the present disclosure within the scope of the present disclosure.

For example, some or all of the above-described example embodiments may be described in supplementary notes below, but are not limited thereto.

### (Supplementary Note 1)

A deterioration detection system comprising:
an optical fiber that is laid along a wind turbine for power generation;
a communication unit configured to transmit pulsed light to the optical fiber and receive an optical signal including information indicating vibration of the wind turbine from the optical fiber; and
a detection unit configured to detect deterioration of the wind turbine on the basis of the information indicating the vibration of the wind turbine, the information being included in the optical signal.

### (Supplementary Note 2)

The deterioration detection system according to Supplementary Note 1, wherein the optical fiber is laid along a tower housing of the wind turbine.

### (Supplementary Note 3)

The deterioration detection system according to Supplementary Note 1 or 2, wherein the detection unit is configured to
learn a correspondence relationship between a power generation amount and a vibration frequency of the wind turbine in advance,
derive the vibration frequency of the vibration generated in the wind turbine on the basis of the information indicating the vibration of the wind turbine, and
determine that the wind turbine has deteriorated in a case where the power generation amount corresponding to the vibration frequency of the vibration generated in the wind turbine is out of a predetermined range.

### (Supplementary Note 4)

The deterioration detection system according to any one of Supplementary Notes 1 to 3, wherein, in a portion other than the wind turbine, the optical fiber is laid along a power transmission cable connected to the wind turbine.

### (Supplementary Note 5)

The deterioration detection system according to Supplementary Note 4, wherein the detection unit further detects deterioration of the power transmission cable on the basis of information indicating vibration of the power transmission cable, the information being included in the optical signal.

### (Supplementary Note 6)

The deterioration detection system according to any one of Supplementary Notes 1 to 5, wherein
the optical fiber is laid along a plurality of wind turbines, and
the detection unit detects deterioration of each of the plurality of wind turbines on the basis of information indicating vibration of each of the plurality of wind turbines, the information being included in the optical signal.

### (Supplementary Note 7)

The deterioration detection system according to any one of Supplementary Notes 1 to 6, further comprising a notification unit configured to notify a predetermined notification destination that the wind turbine has deteriorated in a case where the detection unit determines that the wind turbine has deteriorated.

### (Supplementary Note 8)

A deterioration detection apparatus comprising:
a communication unit configured to transmit pulsed light to an optical fiber laid along a wind turbine for power generation and receive an optical signal including information indicating vibration of the wind turbine from the optical fiber; and
a detection unit configured to detect deterioration of the wind turbine on the basis of the information indicating the vibration of the wind turbine, the information being included in the optical signal.

### (Supplementary Note 9)

The deterioration detection apparatus according to Supplementary Note 8, wherein the optical fiber is laid along a tower housing of the wind turbine.

### (Supplementary Note 10)

The deterioration detection apparatus according to Supplementary Note 8 or 9, wherein the detection unit is configured to
learn a correspondence relationship between a power generation amount and a vibration frequency of the wind turbine in advance,
derive the vibration frequency of the vibration generated in the wind turbine on the basis of the information indicating the vibration of the wind turbine, and
determine that the wind turbine has deteriorated in a case where the power generation amount corresponding to the vibration frequency of the vibration generated in the wind turbine is out of a predetermined range.

### (Supplementary Note 11)

The deterioration detection apparatus according to any one of Supplementary Notes 8 to 10, wherein, in a portion other than the wind turbine, the optical fiber is laid along a power transmission cable connected to the wind turbine.

### (Supplementary Note 12)

The deterioration detection apparatus according to Supplementary Note 11, wherein the detection unit further detects deterioration of the power transmission cable on the basis of information indicating vibration of the power transmission cable, the information being included in the optical signal.

### (Supplementary Note 13)

The deterioration detection apparatus according to any one of Supplementary Notes 8 to 12, wherein
the optical fiber is laid along a plurality of wind turbines, and
the detection unit detects deterioration of each of the plurality of wind turbines on the basis of information indicating vibration of each of the plurality of wind turbines, the information being included in the optical signal.

### (Supplementary Note 14)

The deterioration detection apparatus according to any one of Supplementary Notes 8 to 13, further comprising a notification unit configured to notify a predetermined notification destination that the wind turbine has deteriorated in a case where the detection unit determines that the wind turbine has deteriorated.

### (Supplementary Note 15)

A deterioration detection method performed by a deterioration detection apparatus, the deterioration detection method comprising:
a communication step of transmitting pulsed light to an optical fiber laid along a wind turbine for power generation and receiving an optical signal including information indicating vibration of the wind turbine from the optical fiber; and
a detection step of detecting deterioration of the wind turbine on the basis of the information indicating the vibration of the wind turbine, the information being included in the optical signal.

### (Supplementary Note 16)

The deterioration detection method according to Supplementary Note 15, wherein the optical fiber is laid along a tower housing of the wind turbine.

### (Supplementary Note 17)

The deterioration detection method according to Supplementary Note 15 or 16, wherein the detection step includes
learning a correspondence relationship between a power generation amount and a vibration frequency of the wind turbine in advance,
deriving the vibration frequency of the vibration generated in the wind turbine on the basis of the information indicating the vibration of the wind turbine, and
determining that the wind turbine has deteriorated in a case where the power generation amount corresponding to the vibration frequency of the vibration generated in the wind turbine is out of a predetermined range.

### (Supplementary Note 18)

The deterioration detection method according to any one of Supplementary Notes 15 to 17, wherein, in a portion other than the wind turbine, the optical fiber is laid along a power transmission cable connected to the wind turbine.

### (Supplementary Note 19)

The deterioration detection method according to Supplementary Note 18, wherein the detection step further includes detecting deterioration of the power transmission cable on the basis of information indicating vibration of the power transmission cable, the information being included in the optical signal.

### (Supplementary Note 20)

The deterioration detection method according to any one of Supplementary Notes 15 to 19, wherein
the optical fiber is laid along a plurality of wind turbines, and
the detection step includes detecting deterioration of each of the plurality of wind turbines on the basis of information indicating vibration of each of the plurality of wind turbines, the information being included in the optical signal.

### (Supplementary Note 21)

The deterioration detection method according to any one of Supplementary Notes 15 to 20, further comprising a notification step of notifying a predetermined notification destination that the wind turbine has deteriorated in a case where it is determined in the detection step that the wind turbine has deteriorated.

### REFERENCE SIGNS LIST

10 OPTICAL FIBER
20 DETERIORATION DETECTION APPARATUS
21 COMMUNICATION UNIT
22 DETECTION UNIT
23 NOTIFICATION UNIT
30, 30A, 30B WIND TURBINE
31 TOWER HOUSING
32 BLADE
33 ROTATION SHAFT
40 POWER TRANSMISSION CABLE
50 COMPUTER
51 PROCESSOR
52 MEMORY
53 STORAGE
54 INPUT AND OUTPUT INTERFACE
541 DISPLAY APPARATUS
542 INPUT APPARATUS
543 SOUND OUTPUT APPARATUS
55 COMMUNICATION INTERFACE

What is claimed is:

1. A deterioration detection system comprising:
an optical fiber that is laid along a wind turbine for power generation;
at least one memory storing instructions, and
at least one processor configured to execute the instructions to;
transmit pulsed light to the optical fiber and receive an optical signal including information indicating vibration of the wind turbine from the optical fiber; and
detect deterioration of the wind turbine on the basis of the information indicating the vibration of the wind turbine, the information being included in the optical signal.

2. The deterioration detection system according to claim 1, wherein the optical fiber is laid along a tower housing of the wind turbine.

3. The deterioration detection system according to claim 1, wherein the at least one processor is further configured to execute the instructions to
learn a correspondence relationship between a power generation amount and a vibration frequency of the wind turbine in advance,
derive the vibration frequency of the vibration generated in the wind turbine on the basis of the information indicating the vibration of the wind turbine, and
determine that the wind turbine has deteriorated in a case where the power generation amount corresponding to the vibration frequency of the vibration generated in the wind turbine is out of a predetermined range.

4. The deterioration detection system according to claim 1, wherein, in a portion other than the wind turbine, the optical fiber is laid along a power transmission cable connected to the wind turbine.

5. The deterioration detection system according to claim 4, wherein the at least one processor is further configured to execute the instructions to further detect deterioration of the power transmission cable on the basis of information indicating vibration of the power transmission cable, the information being included in the optical signal.

6. The deterioration detection system according to claim 1, wherein
the optical fiber is laid along a plurality of wind turbines, and
the at least one processor is further configured to execute the instructions to detect deterioration of each of the plurality of wind turbines on the basis of information indicating vibration of each of the plurality of wind turbines, the information being included in the optical signal.

7. The deterioration detection system according to claim 1, wherein the at least one processor is further configured to execute the instructions to notify a predetermined notification destination that the wind turbine has deteriorated in a case where it is determined that the wind turbine has deteriorated.

8. A deterioration detection apparatus comprising:
at least one memory storing instructions, and
at least one processor configured to execute the instructions to;
transmit pulsed light to an optical fiber laid along a wind turbine for power generation and receive an optical signal including information indicating vibration of the wind turbine from the optical fiber; and
detect deterioration of the wind turbine on the basis of the information indicating the vibration of the wind turbine, the information being included in the optical signal.

9. The deterioration detection apparatus according to claim 8, wherein the optical fiber is laid along a tower housing of the wind turbine.

10. The deterioration detection apparatus according to claim 8, wherein the at least one processor is further configured to execute the instructions to
learn a correspondence relationship between a power generation amount and a vibration frequency of the wind turbine in advance,
derive the vibration frequency of the vibration generated in the wind turbine on the basis of the information indicating the vibration of the wind turbine, and
determine that the wind turbine has deteriorated in a case where the power generation amount corresponding to the vibration frequency of the vibration generated in the wind turbine is out of a predetermined range.

11. The deterioration detection apparatus according to claim 8, wherein, in a portion other than the wind turbine, the optical fiber is laid along a power transmission cable connected to the wind turbine.

12. The deterioration detection apparatus according to claim 11, wherein the at least one processor is further configured to execute the instructions to further detect deterioration of the power transmission cable on the basis of information indicating vibration of the power transmission cable, the information being included in the optical signal.

13. The deterioration detection apparatus according to claim 8, wherein
the optical fiber is laid along a plurality of wind turbines, and
the at least one processor is further configured to execute the instructions to detect deterioration of each of the plurality of wind turbines on the basis of information indicating vibration of each of the plurality of wind turbines, the information being included in the optical signal.

14. The deterioration detection apparatus according to claim 8, wherein the at least one processor is further configured to execute the instructions to notify a predetermined notification destination that the wind turbine has deteriorated in a case where it is determined that the wind turbine has deteriorated.

15. A deterioration detection method performed by a deterioration detection apparatus, the deterioration detection method comprising:
a communication step of transmitting pulsed light to an optical fiber laid along a wind turbine for power generation and receiving an optical signal including information indicating vibration of the wind turbine from the optical fiber; and
a detection step of detecting deterioration of the wind turbine on the basis of the information indicating the vibration of the wind turbine, the information being included in the optical signal.

16. The deterioration detection method according to claim 15, wherein the optical fiber is laid along a tower housing of the wind turbine.

17. The deterioration detection method according to claim 15, wherein the detection step includes
learning a correspondence relationship between a power generation amount and a vibration frequency of the wind turbine in advance,
deriving the vibration frequency of the vibration generated in the wind turbine on the basis of the information indicating the vibration of the wind turbine, and
determining that the wind turbine has deteriorated in a case where the power generation amount corresponding to the vibration frequency of the vibration generated in the wind turbine is out of a predetermined range.

18. The deterioration detection method according to claim 15, wherein, in a portion other than the wind turbine, the optical fiber is laid along a power transmission cable connected to the wind turbine.

19. The deterioration detection method according to claim 18, wherein the detection step further includes detecting deterioration of the power transmission cable on the basis of information indicating vibration of the power transmission cable, the information being included in the optical signal.

20. The deterioration detection method according to claim 15, wherein
the optical fiber is laid along a plurality of wind turbines, and
the detection step includes detecting deterioration of each of the plurality of wind turbines on the basis of information indicating vibration of each of the plurality of wind turbines, the information being included in the optical signal.

21. (canceled)
